(19) United States
(12) Patent Application Publication
(10) Pub. No.: US 2025/0283978 A1
(43) Pub. Date: Sep. 11, 2025

(54) METHOD AND SYSTEM FOR ESTIMATING FOREST CARBON STORAGE

(71) Applicant: GREEN DATA TECHNOLOGY LIMITED, HONG KONG (CN)

(72) Inventor: JIANGYING DENG, HONG KONG (CN)

(21) Appl. No.: 18/769,581

(22) Filed: Jul. 11, 2024

(30) Foreign Application Priority Data
Mar. 11, 2024 (HK) 32024088499.1

(51) Int. Cl. G01S 7/48; G01S 17/89; G06T 7/40; G06T 7/62; G06V 10/82; G06V 20/10; G06V 20/13

(52) U.S. Cl. CPC G01S 7/4802; G01S 17/89; G06T 7/40; G06T 7/62; G06V 10/82; G06V 20/13; G06V 20/188; G06T 2207/10036; G06T 2207/20084; G06T 2207/30188

(57) ABSTRACT

The present invention relates to a method and system for estimating forest carbon storage that combines artificial intelligence algorithms and multimodal remote sensing data. This approach comprehensively utilizes laser radar satellites, multi-/hyperspectral satellites, radar satellites, high-resolution optical imagery, etc. A hybrid technical system is employed for different forest coverage areas, resulting in high-precision forest carbon storage mapping with a resolution of 10 meters and area coverage. This provides technical support and assurance for assessing global forest carbon storage and supporting forestry carbon sequestration transactions.

### CROSS REFERENCE

This application claims the benefit of H.K. Short-term patent, Application No. 32024088499.1, filed on Mar. 11, 2024, titled “A METHOD AND SYSTEM FOR ESTIMATING FOREST CARBON STORAGE,” which is hereby incorporated by reference in its entirety.

### TECHNICAL FIELD

The present invention relates to a method and system for estimating forest carbon storage that combines artificial intelligence algorithms and multimodal remote sensing data.

### BACKGROUND

Ecological and botanical studies have demonstrated that forest carbon storage can be accurately estimated through measurements of parameters such as tree height, diameter at breast height (DBH), stand age, and tree species. Among these parameters, obtaining accurate tree height data on a large scale and at low cost has long been a challenge in estimating forest carbon storage. In recent years, with the development of laser radar satellite technology, the utilization of data from emerging laser satellites such as GEDI and ICESAT-2 to acquire tree height information, combined with various regression and machine learning methods, has enabled the generation of comprehensive tree height products using optical satellites as proxies. This has paved the way for estimating forest carbon storage and has become a new and popular research direction.

However, within this technological framework, there exist two key bottlenecks. Firstly, obtaining tree height products in high-latitude regions poses a challenge. Due to the orbit of GEDI, it is unable to cover high-latitude areas directly and can only estimate them through extrapolation. Particularly after 2023, when GEDI ceased observations, the acquisition of high-quality tree height products has been further constrained.

Secondly, estimating carbon storage in sparse forest areas is problematic. The resolution of multi-/hyperspectral remote sensing products is typically above 10 meters, leading to significant biases when mapping sparse forest areas.

### SUMMARY

The present invention provides a method and system for estimating forest carbon storage that combines artificial intelligence algorithms and multimodal remote sensing data. The method and system approach comprehensively utilizes laser radar satellites, multi-/hyperspectral satellites, radar satellites, high-resolution optical imagery, etc. A hybrid technical system is employed for different forest coverage areas, resulting in high-precision forest carbon storage mapping with a resolution of 10 meters and area coverage. This provides technical support and assurance for assessing global forest carbon storage and supporting forestry carbon sequestration transactions.

### BRIEF DESCRIPTION OF THE DRAWINGS

FIG. 1 shows the system and its features according to an embodiment of the present invention.

FIG. 2 shows a flowchart of the method for estimating forest carbon storage according to an embodiment of the present invention.

### DETAILED DESCRIPTION

All the technical terms being used in the present invention have the same meaning as commonly understood by a person of ordinary skill in the art to which this invention belongs.

In order to achieve accurate, cost-effective, large-scale, high-resolution forest carbon storage estimation, and frequent updates globally, the present invention provides a tree height determination algorithm based on full waveform decomposition technology. This algorithm equips the DQ-1 ACDL payload, originally designed for atmospheric measurements, with tree height measurement capabilities. Since the satellite orbits in a polar sun-synchronous orbit, it can effectively cover latitudes between 80° N and 80° S, thereby resolving the lack of high-quality tree height products in high-latitude regions.

Additionally, a single-tree recognition algorithm based on lightweight networks combined with attention mechanisms is also provided. This algorithm can utilize optical satellite imagery with resolutions of 1 meter or higher to identify individual canopy layers and quantify their diameters in sparsely forested areas. Finally, an allometric growth method is employed to calculate the carbon storage of the entire forest area. By combining these two technological approaches, the remote sensing inventory task for global forest carbon storage is accomplished.

The present invention provides a forest carbon storage estimation method that combines artificial intelligence with multimodal remote sensing data. It is used to obtain high-resolution and accurate forest carbon storage products globally.

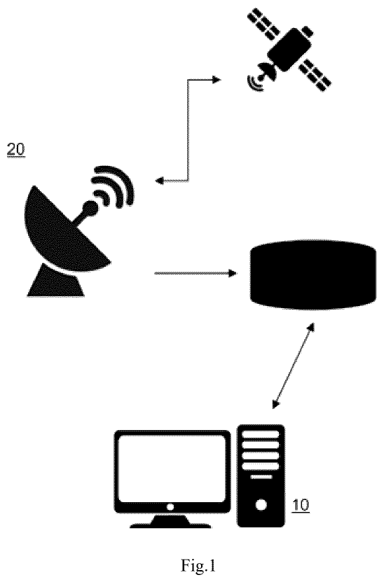

Referring to FIG. 1, there is shown the system involved in implementing the method of estimating the carbon storage of a forest. The present invention is implemented by way of computer system involving a computer system 10, and a set of satellites 20 providing satellite data to the computer system.

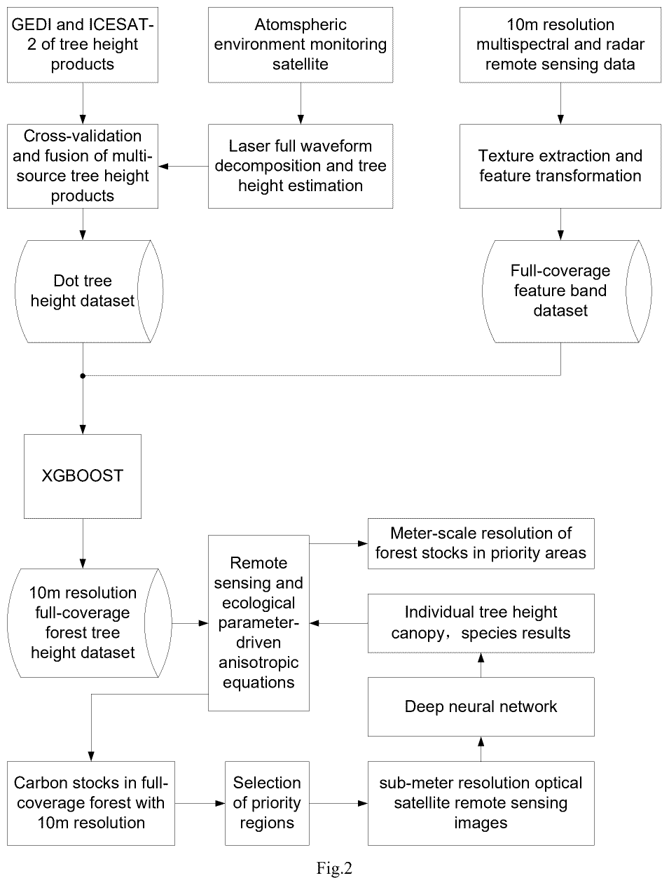

Referring to FIG. 2, The system and method employ a CatBoost-based or XGBoost-based method, integrating synthetic aperture radar, multi-/hyperspectral, digital elevation model, rainfall, temperature, and other multisource data, to generate tree height products with a resolution of 10 meters and area coverage.

The system and method further utilize high-resolution satellite imagery ranging from meters to sub-meters, a lightweight YOLOv5 network combined with attention mechanisms such as Dynamic Convolution, SimAM attention model, and ParallelPolarized improved model is utilized for individual tree recognition and parameter estimation.

A hybrid strategy is adopted wherein, in densely forested areas, area-domain tree height products serve as the core to generate 10 m-resolution carbon storage estimates, while in sparsely forested regions, single-tree identification products are used to generate vectorized forest carbon storage products, which are then aggregated into 10 m-resolution carbon storage products.

Step 1: Preprocessing satellite data from different sources.

Satellite data provided by the different multiple sources are preprocessed by the present invention in order to have a consistent spatial reference system. Additionally, certain feature transformations are applied to extract texture information. The preprocessing done are radiometric calibration, atmospheric correction, and geometric correction performed on the raw multispectral/hyperspectral remote sensing data from said multiple satellite data sources.

### Radiometric Calibration:

Radiometric calibration refers to the process of converting DN values to radiance values, where DN values represent the brightness values of remote sensing image pixels, recording the grayscale values of objects on the ground, and radiance values (radiance) represent the radiance received by the satellite. The calculation method is as follows:

$${L}_{λ} = Gain \cdot DN + Bias \qquad ( 1 )$$

Where L_{λ} represents the radiance value, DN represents the image pixel value, Gain represents the gain value, and Bias represents the offset value.

Then, atmospheric apparent reflectance is calculated from radiance values:

$${ρ}_{λ} = \frac{π {L}_{λ} {d}^{2}}{{ESUN}_{λ} sin θ} \qquad ( 2 )$$

Where ρ_{λ} represents the atmospheric apparent reflectance, L_{λ} represents the radiance value, d represents the distance between the sun and the earth, ESUN_{λ} represents the solar irradiance, and θ represents the solar zenith angle.

### Atmospheric Correction:

Atmospheric correction is the process of converting apparent reflectance or radiance values to actual surface reflectance, eliminating radiation errors caused by atmospheric effects such as atmospheric scattering, absorption, and reflection, to obtain the true surface reflectance.

### Geometric Correction:

Geometric correction primarily corrects geometric distortions caused by systematic and non-systematic factors. By utilizing ground control points to rectify various geometric deformations, the images are geographically positioned to obtain genuine coordinate information. This process involves two steps: coordinate transformation and resampling.

### Texture Extraction:

Texture feature refers to numerous regular or irregular similar elements or graphic structures within an image, characterized by strong or weak regularity. It generally encompasses variations and repetitions of grayscale values in spatial dimensions, or recurrent local patterns (texture units) and their arrangement rules within the image. In this context, the texture features may include the mean, variance, contrast, homogeneity, dissimilarity, entropy, angular second moment matrix, and correlation of remote sensing images. The calculation formulas are as follows:

TABLE 1
Texture Feature Calculation Formulas

| Metrics | Formulas |
|---|---|
| Mean | $Mean = \frac{1}{M N} {\sum }_{i = 0}^{M - 1} {\sum }_{j = 0}^{N - 1} i \cdot f ( i , j )$ |
| Variance | $Variance = {\sum }_{i = 0}^{M - 1} {\sum }_{j = 0}^{N - 1} {( 1 - Mean )}^{2} \cdot f ( i , j )$ |
| Contrast | $Contrast = {\sum }_{i = 0}^{M - 1} {\sum }_{j = 0}^{N - 1} {( i - j )}^{2} \cdot f ( i , j )$ |
| Homogeneity | $Homogeneity = {\sum }_{i = 0}^{M - 1} {\sum }_{j = 0}^{N - 1} \frac{f ( i , j )}{1 + {( i - j )}^{2}}$ |
| Dissimilarity | $Dissmilarity = {\sum }_{i = 0}^{M - 1} {\sum }_{j = 0}^{N - 1} \vert i - j \vert \cdot f ( i , j )$ |
| Entropy | $Entropy = {\sum }_{i = 0}^{M - 1} {\sum }_{j = 0}^{N - 1} f ( i , j ) \cdot Inf ( i , j )$ |
| Angular Second Moment Matrix | $A S M = {\sum }_{i = 0}^{M - 1} {\sum }_{j = 0}^{N - 1} {f ( i , j )}^{2}$ |
| Correlation | $Correlation = {\sum }_{i = 0}^{M - 1} {\sum }_{j = 0}^{N - 1} \frac{( i - Mean ) \cdot ( j - Mean ) \cdot {f ( i , j )}^{2}}{Variance}$ |

### Feature Transformation

Perform principal component analysis (PCA) on the calculated texture features to reduce dimensionality. Due to the excessive and redundant nature of the aforementioned features, a feature transformation method is employed to extract a more representative dataset of features with full coverage. The primary objective is to ensure that the covariance between the new features is zero.

$${C}^{‵} = \frac{1}{m - 1} {Y}^{T} Y \qquad ( 3 )$$

Y represents the matrix after feature transformation, where m denotes the number of samples in the original matrix.

Step 2: Decomposing the full-waveform data to estimate tree height accordingly.

The full waveform data from the spaceborne laser radar is subjected to spectral energy decomposition to separate ground echoes from canopy echoes. Ground elevation and canopy height are then determined separately, allowing for the calculation of forest canopy height through differencing. Said full waveform data provided is sourced from LiDAR (Light Detection and Ranging) satellite.

To obtain relatively accurate waveform parameter information, it is assumed that the reflected pulse is bell-shaped, and the waveform is decomposed using Gaussian decomposition theory. Then, by solving the first and second-order partial derivatives of the distribution function and setting them to zero, the inflection points of the filtered waveform data and the positions of the initial peaks are obtained. The corresponding first and second-order partial derivatives are:

$$\frac{\partial {W}_{m}}{\partial t} = - {A}_{m} {e}^{- \frac{{( t - {t}_{m} )}^{2}}{2 {σ}_{m}^{2}}} \times \frac{{( t - {t}_{m} )}^{2}}{{σ}_{m}^{2}} , \qquad ( 4 )$$

$$\frac{{\partial }^{2} {W}_{m}}{\partial {t}^{2}} = {A}_{m} {e}^{- \frac{{( t - {t}_{m} )}^{2}}{2 {σ}_{m}^{2}}} \times [ \frac{{( t - {t}_{m} )}^{2}}{{σ}_{m}^{2}} - \frac{1}{{σ}_{m}^{2}} ] , \qquad ( 5 )$$

In this context, Aₘ represents the amplitude of the m-th sub-waveform,

$$\frac{\partial {W}_{m}}{\partial t} and \frac{{\partial }^{2} {W}_{m}}{\partial {t}^{2}}$$

denote the first and second derivatives of the m-th sub-waveform, respectively.

Therefore, based on the aforementioned theoretical foundation, it is possible to obtain the location parameters corresponding to the respective sub-waveforms. To better fit the data obtained from experiments, the present invention establishes a spectral energy model and fits each sub-waveform to obtain the parameters of the spectral energy model. The corresponding spectral energy formula is as follows:

$$F = f - c . \frac{{e}^{g ( x - d ) ( \frac{1}{a} - \frac{1}{b} )}}{{e}^{g ( x - d ) ( \frac{1}{a} + \frac{1}{b} )} + {e}^{- g ( x - d ) ( \frac{1}{a} + \frac{1}{b} )}} ,$$

In Equation 6, the parameters are defined as follows: a=¼(1/τᵣ−1/τ_{f}) and b=¼(1/τᵣ+1/τ_{f}). The parameters τᵣ and τ_{f} represent the rise and fall times in the waveform signal, respectively. Additionally, parameter d denotes the center of the sub-waveform component and also represents the distance of the LiDAR signal transmission. For the remaining parameters a, b, c and f, they need to be reconstructed from the discrete LiDAR signal data. In other words, parameters a, b, c and f need to be obtained through fitting.

The fitting based on the spectral energy model equation can yield corresponding parameter sets. However, to obtain more accurate parameter sets, this paper introduces the Levenberg-Marquardt algorithm, which optimizes the parameters of the spectral energy model for the first time. Building upon the Levenberg-Marquardt algorithm, this paper modifies the core function of the algorithm. Initially based on the Gaussian function, it is modified to a core function that better fits the spectral energy model. The Levenberg-Marquardt method is abbreviated as the L-M method. This method is a combination of the steepest descent method and the linearization method (Taylor series).

The L-M method obtains the search direction by solving the following optimization model:

$${d}_{k} = arg {min}_{d ∈ {R}^{n}} {‖ {J}_{k} d + {r}_{k} ‖}^{2} + {μ}_{k} {‖ d ‖}^{2} , \qquad ( 7 )$$

Where, μₖ>0, and according to the optimality condition dₖ satisfies:

$$( {J}_{k}^{T} {J}_{k} + {μ}_{k} I ) {d}_{k} + {J}_{k}^{T} {r}_{k} = 0 , \qquad ( 8 )$$

$${d}_{k} = - {( {J}_{k}^{T} {J}_{k} + {μ}_{k} I )}^{- 1} {J}_{k}^{T} r ( {x}_{k} ) , \qquad ( 9 )$$

In fact, utilizing the optimality condition of constrained optimization problems, the L-M method can be viewed as inspired by the trust region method for the Gauss-Newton method, because dₖ can be seen as the optimal solution to the following constrained optimization problem:

$$min \{ {‖ {J}_{k} d + {r}_{k} ‖}^{2} \vert d ∈ {R}^{n} , ‖ d ‖ \leq {Δ}_{k} \} , Where , {Δ}_{k} = ‖ {d}_{k} ‖ . \qquad ( 10 )$$

The descent property of dₖ is discussed below: if gₖ=Jₖ^{T}rₖ≠0, then for any μₖ>0.

$${d}_{k}^{T} ( - {g}_{k} ) = {( {J}_{k}^{T} {r}_{k} )}^{T} {( {J}_{k}^{T} {J}_{k} + {μ}_{k} I )}^{- 1} {J}_{k}^{T} r ( {x}_{k} ) > 0 , \qquad ( 11 )$$

So dₖ is the descent direction of f(x) at the point xₖ By introducing line search, this research obtains the Levenberg-Marquardt (L-M) method for nonlinear least squares:

$${x}_{k + 1} = {x}_{k} + {α}_{k} {d}_{k} , \qquad ( 12 )$$

Step 3: Generating full-coverage forest tree height dataset with 10-meter resolution.

Signals from synthetic aperture radar with different polarizations, multiband reflectance and texture from multispectral/hyperspectral remote sensing products, slope aspect, and temperature and precipitation parameters are utilized as decision variables input into a neural network model for training. This process yields 10-meter-resolution area-domain tree height products.

Utilizing the point cloud LiDAR tree height dataset obtained from the aforementioned steps and the full-coverage feature band dataset, the 10 m resolution full-coverage forest tree height dataset is obtained using the Neural Network Guided Interpolation (NNGI) method.

In this step, the main focus is on using neural network-guided interpolation to fuse and enhance the spatial resolution of the point cloud LiDAR tree height dataset and the full-coverage feature band dataset. The NNGI method serves as the core of the mapping framework and is derived inspired by Kriging interpolation.

$$Z ( {l}_{o} ) = {\sum }_{{l}_{i} ∈ ( {l}_{o} )} {λ}_{i} ( {l}_{o} ) Z ( {l}_{i} ) + {λ}_{o} ( {l}_{o} ) \qquad ( 13 )$$

Where Z(lₒ) is the unknown value to be interpolated at location lₒ, Z(lᵢ) is the known value at location lᵢ, it is the i-th element in the neighborhood set of location lₒ, λᵢ(lₒ) is the weight of Z(lᵢ), and λₒ is a constant depending on the location lₒ. The weights λᵢ(lₒ) are calculated based on the variogram and covariogram. However, the forest canopy height values Z(lₒ) and Z(lᵢ) not only depend on their spatial distance but also on environmental conditions. The Third Law of Geography assumes that projects with similar geographic conditions have a higher degree of correlation. According to the Third Law of Geography, the Kriging interpolation equation (Formula 14) is revised as follows.

$$Z ( {l}_{o} ) = {\sum }_{{l}_{i} ∈ ( {l}_{o} )} Ψ ( {d}_{{l}_{o} , {l}_{i}} ) Z ( {l}_{i} ) + φ ( {v}_{{l}_{o}} ) \qquad ( 14 )$$

Where, Ψ: n→is a function, dₗ_{ₒ} describing the feature distances between location pair (lₒ,lᵢ), lᵢ is the weighted modeling of Z(lᵢ). To interpolate forest canopy height, in Formula 14, Z(lᵢ) is designated as the spatial lidar forest canopy height H(lᵢ), and Ψ and φ are the two functions that need to be solved. Using a multilayer perceptron (MLP) to approximate these two functions, MLP is highly effective in learning arbitrary functions.

The MLP designed to approximate function Ψ consists of four layers, where the first three layers have the same structure (Equation 15):

$$\{ \begin{matrix}{u}_{1} = {d}_{{l}_{o} , {l}_{i}} \\ {u}_{j + 1} = {MLP}_{0} ( {w}_{j}^{T} {u}_{i} ) = ρ ( L N ( {w}_{j}^{T} {u}_{j} ) ) , j = 1 , 2 , 3\end{matrix} \qquad ( 15 )$$

where wⱼ is the weight to be learned in the j-th layer during the training process; uⱼ₊₁ is the output of the j-th layer and the input of the j+1-th layer; LN is the layer normalization function used to ensure that MLP is not affected by feature shifts and scaling under each training condition; ρ is the non-linear activation function ReLU. Before sending the output u₄ to the fourth layer, Dropout sets 20% of the units of u₄ to 0 in each training step to eliminate overfitting. Finally, the fourth layer generates interpolation weights λᵢ for neighborhood lᵢ through linear transformation.

$${λ}_{i} = Ψ ( {d}_{{l}_{o} , {l}_{i}} ) = {w}_{4} {u}_{4}^{′} \qquad ( 16 )$$

Where, u₄′ represents the result of Dropout. To form a set of adjacent spaceborne LiDAR footprints (lₒ) at a given location lₒ, the eight nearest footprints are identified from both GEDI and ACDL. There are four footprints on each side of the spaceborne LiDAR platform. The adjacent footprints from both sides of GEDI and ACDL are utilized to reduce the impact of conventional sampling from a single spaceborne LiDAR platform. To enhance the efficiency of forming (lₒ), an orbit-assist search method is employed. For each position pair in the observation pairs, a feature difference vector dₗ_{ₒ}_{,l}_{ᵢ} is extracted and used as a predictive factor to train the designed MLP to approximate the function Ψ. The feature difference vector contains six features, including Δx, Δy, Δe, Δs, Δa and Δn, representing the feature distances of longitude, latitude, elevation, slope, height difference, and NDVI, respectively.

The MLP designed to approximate the function φ also consists of four layers, where the weights for the j-th layer are denoted as w′ⱼ. It functions as a regression model to estimate the constant λ₀(l₀), similar to regression-kriging. The input for the MLP designed to approximate φ is a geographic condition vector e, s, a, n, pm, ps, tm, ts, where e, s, a, n, pm, ps, tm, ts represent elevation, slope, aspect, NDVI, mean annual temperature, temperature seasonality, mean annual precipitation, and precipitation seasonality, respectively. According to Equation 14, ĥₒ represents the final interpolated forest canopy height at point lₒ.

$${\hat{h}}_{o} = {\sum }_{{l}_{i} ∈ ( {l}_{o} )} {λ}_{i} H ( {l}_{i} ) + φ ( {v}_{{l}_{o}} ) \qquad ( 17 )$$

Step 4: Estimating forest carbon storage of sparsely forested regions, based on the identified individual trees.

Utilizing a lightweight YOLOv5 network with attention mechanisms, individual trees are identified on high-resolution satellite imagery, and their canopy diameters are measured. Tree height parameters are then estimated based on tree species information.

Through the lightweight network YOLOv5 combined with attention mechanisms such as Dynamic Convolution, the attention model SimAM, and the improved model ParallelPolarized, along with data augmentation, real target box retraining methods to enhance data quality, and image fusion and overlapping sliding window detection methods, a high-resolution forest carbon stock distribution is obtained based on sub-meter resolution optical satellite remote sensing images.

Based on sub-meter resolution optical satellite remote sensing images, single tree height and canopy labeling are performed. The labeled sample library undergoes preprocessing using geometric distortion methods, and Mosaic data augmentation is applied to the sample images before entering the YOLOv5 network.

In the YOLOv5x model's Backbone section, the C3 modules are replaced with the ParallelPolarized self-attention modules at the second, fourth, sixth, and eighth layers.

In the Neck section of the YOLOv5x model, three attention modules based on the SimAM attention model and one attention module based on Dynamic Conv are constructed. The SimAM module consists of a Conv layer, an upsampling layer, a Concat layer, three C3 layers, and a SimAM layer. The Dynamic Conv module includes a Dynamic Conv layer, three C3 layers, and a SimAM layer.

A new detection head is added to the Head section of the YOLOv5x model, with layers 24, 29, 34, and 39 serving as the output layers.

The real target boxes and label information obtained from the trained dataset and test dataset are used as training samples and re-entered into the model for retraining, which can increase the sample capacity and improve the training effect to some extent.

Image fusion processing is performed on the images, combining panchromatic images with multispectral images to obtain fusion images with high spatial and spectral resolution.

When the sub-meter resolution optical satellite remote sensing images enter the model, the strategy of overlapping sliding window detection is adopted, using 64×64 size windows with a 20% overlap sliding detection on the sub-meter resolution optical satellite remote sensing images.

Non-maximum suppression is applied to the images generated by sliding window detection, merging the predicted boxes on different windows for the same target in the overlapping area to obtain the final extraction results.

The coordinates and slices output by the sub-meter resolution optical satellite remote sensing images identifying single tree heights are used to construct a single tree height and canopy database.

Using the above lightweight network YOLOv5 results for single tree height, canopy, and tree species, the power-law equation is applied to these results. The parameters corresponding to the power-law equations of different tree species are solved separately. Using the power-law equations of different tree species, their aboveground biomass and carbon stock are calculated, ultimately obtaining the distribution of forest carbon stock in sparse forest areas at the sub-meter resolution.

Step 5: Estimating forest carbon storage by using anisotropic equation.

A hybrid strategy is employed wherein different tree height products are used to drive allometric growth equations for dense and sparse forests separately. This approach yields comprehensive 10-meter-resolution aboveground biomass coverage, and forest carbon storage results are calculated based on conversion coefficients.

Through the aforementioned steps, remote sensing estimation of carbon storage for forests across all latitudes, both dense and sparse, can be achieved with a spatial resolution of 10 meters and an update frequency of up to 1 year, or even higher.

The 10-meter resolution full-coverage forest tree height remote sensing dataset and ecological parameters are utilized to drive the power-law equation, aiming to derive the 10 m resolution full-coverage carbon stock.

The 10-meter resolution full-coverage forest tree height dataset from sample plots and tree diameter data are utilized to calculate the aboveground biomass (AGB) using a general power-law equation. Subsequently, regression analysis is conducted between the calculated biomass and forest canopy height to establish a power-law function equation, which is then logarithmically transformed:

$$ln ( y ) = a + b \cdot ln ( H ) \qquad ( 18 )$$

Where y represents aboveground biomass, H represents tree height, and a and b are the parameters to be determined, thereby establishing the calculation relationship between tree height and biomass. Based on this relationship, the aboveground biomass at 10 m resolution full coverage can be computed.

According to the aboveground biomass (AGB), carbon stock (AGC) is estimated to obtain 10 meters resolution full coverage carbon stock. Generally, it is considered that carbon stock accounts for 47% of the biomass.

$$A G C = 0.47 \cdot AGB \qquad ( 19 )$$

From the 10-meter resolution full coverage carbon stock data, select areas affected by droughts, wildfires, or large-scale human disturbances as focal research regions, and acquire sub-meter resolution optical satellite remote sensing images of these focal areas.

The detailed description provided should not be construed as the limitation of the present invention. Modifications of the present invention as described may be obvious to a person skilled in the art.

The appended claims define the scope and limitations of the present invention and what is considered by the inventors to be the invention. The essential features are defined and claimed thereto.

1. A method for estimating forest carbon storage, comprising:
receiving satellite data from multiple sources;
performing a first process on a first part of the satellite data, to generate a full-coverage forest tree height dataset with an ideal resolution;
performing a second process on a second part of the satellite data, to identify individual tree and obtain tree parameters of each identify tree; wherein the tree parameters comprises a canopy diameter, a tree height and a tree species;
using an anisotropic equation to estimate a forest carbon storage dataset;
wherein densely forested regions of the forest carbon storage dataset is estimated based on the full-coverage forest tree height dataset and sparsely forested regions of the forest carbon storage dataset is estimated based on the tree parameters of each identify tree.

2. The method according to claim 1, wherein the first part of the satellite data comprises remote sensing data from multiple sources and full-waveform data from LiDAR;
wherein the first process comprises:
preprocessing the remote sensing data to generate a preprocessed remote sensing data in a consistent spatial reference system;
performing a texture extraction and a feature transformation on the preprocessed remote sensing data to generate a full-coverage feature band dataset;
performing a waveform decomposition and a tree height estimation on the full-waveform data to generate a dot tree height dataset;
integrating the full-coverage feature band dataset with the dot tree height dataset to generate a full-coverage forest tree height dataset with an ideal resolution.

3. The method according to claim 2, wherein the step of preprocessing the remote sensing data to generate a preprocessed data in a consistent spatial reference system, comprising:
performing a radiometric calibration, an atmospheric correction and a geometric correction on the remote sensing data from multiple sources, to generate the preprocessed data.

4. The method according to claim 2, wherein the waveform decomposition comprises:
decomposing the full-waveform data into multiple sub-waves, by using Gaussian decomposition;
obtaining location parameters of each sub-wave;
identifying ground echoes and canopy echoes among the multiple sub-waves, according to the location parameters;
wherein the ground echo and the canopy echo is identified by a spectral energy model.

5. The method according to claim 3, wherein the tree height estimation comprises
calculating a height difference between the ground echo and the canopy echo to determine a forest canopy height.

6. The method according to claim 2, wherein the texture extraction comprises:
extracting at least one texture features of the preprocessed remote sensing data;
wherein the texture feature is selected from one or more of the following:
mean, variance, contrast, homogeneity, dissimilarity, entropy, angular second moment matrix, and correlation of the;
wherein the feature transformation comprise:
performing a principal component analysis (PCA) on the extracted texture features to reduce dimensionality.

7. The method according to claim 2, wherein the full-coverage forest tree height dataset with the ideal resolution is generated by using Neural Network Guided Interpolation (NNGI) method and the ideal resolution is 10 meters.

8. The method according to claim 1, wherein the second part of the satellite data comprises optical satellite remote sensing images with sub-meter resolution;
wherein the second process comprises:
using deep neural network (DNN) to identify individual trees on the optical satellite remote sensing images;
determining the tree parameter of each identified tree;
wherein the canopy diameter is measured, the tree height is estimated by the tree species.

9. The method according to claim 8, wherein the DNN is a lightweight YOLOv5 with attention mechanisms comprised of Dynamic Convolution, SimAM attention model, and ParallelPolarized improved model.

10. The method according to claim 1, wherein the method further comprises:
selecting at least one priority area;
receiving the second part of the satellite data for the priority area;
for the priority area, performing the second process on the second part of the satellite data to identify individual tree and obtain tree parameters of each identify tree;
using the anisotropic equation to estimate a forest carbon storage for the priority area, based on the tree parameters of each identified tree.

11. A computer system for estimating forest carbon storage, comprising: a memory and one or more processors, wherein computer-readable instructions are stored in the memory, when the computer-readable instructions are executed by said one or more processors, said one or more processors are made to implement the following steps:
receiving satellite data from multiple sources;
performing a first process on a first part of the satellite data, to generate a full-coverage forest tree height dataset with an ideal resolution;
performing a second process on a second part of the satellite data, to identify individual tree and obtain tree parameters of each identify tree; wherein the tree parameters comprises a canopy diameter, a tree height and a tree species;
using an anisotropic equation to estimate a forest carbon storage dataset;
wherein densely forested regions of the forest carbon storage dataset is estimated based on the full-coverage forest tree height dataset and sparsely forested regions of the forest carbon storage dataset is estimated based on the tree parameters of each identify tree.

12. The computer system according to claim 11, wherein the first part of the satellite data comprises remote sensing data from multiple sources and full-waveform data from LiDAR;
wherein the first process comprises:
preprocessing the remote sensing data to generate a preprocessed remote sensing data in a consistent spatial reference system;
performing a texture extraction and a feature transformation on the preprocessed remote sensing data to generate a full-coverage feature band dataset;
performing a waveform decomposition and a tree height estimation on the full-waveform data to generate a dot tree height dataset;
integrating the full-coverage feature band dataset with the dot tree height dataset to generate a full-coverage forest tree height dataset with an ideal resolution.

13. The computer system according to claim 12, wherein the step of preprocessing the remote sensing data to generate a preprocessed data in a consistent spatial reference system, comprising:
performing a radiometric calibration, an atmospheric correction and a geometric correction on the remote sensing data from multiple sources, to generate the preprocessed data.

14. The computer system according to claim 12, wherein the waveform decomposition comprises:
decomposing the full-waveform data into multiple sub-waves, by using Gaussian decomposition;
obtaining location parameters of each sub-wave;
identifying ground echoes and canopy echoes among the multiple sub-waves, according to the location parameters;
wherein the ground echo and the canopy echo is identified by a spectral energy model.

15. The computer system according to claim 13, wherein the tree height estimation comprises
calculating a height difference between the ground echo and the canopy echo to determine a forest canopy height.

16. The computer system according to claim 12, wherein the texture extraction comprises:
extracting at least one texture features of the preprocessed remote sensing data;
wherein the texture feature is selected from one or more of the following:
mean, variance, contrast, homogeneity, dissimilarity, entropy, angular second moment matrix, and correlation of the;
wherein the feature transformation comprise:
performing a principal component analysis (PCA) on the extracted texture features to reduce dimensionality.

17. The computer system according to claim 12, wherein the full-coverage forest tree height dataset with the ideal resolution is generated by using Neural Network Guided Interpolation (NNGI) method and the ideal resolution is 10 meters.

18. The computer system according to claim 11, wherein the second part of the satellite data comprises optical satellite remote sensing images with sub-meter resolution;
wherein the second process comprises:
using deep neural network (DNN) to identify individual trees on the optical satellite remote sensing images;
determining the tree parameter of each identified tree;
wherein the canopy diameter is measured, the tree height is estimated by the tree species.

19. The computer system according to claim 18, wherein the DNN is a lightweight YOLOv5 with attention mechanisms comprised of Dynamic Convolution, SimAM attention model, and ParallelPolarized improved model.

20. The computer system according to claim 11, wherein the method further comprises:
selecting at least one priority area;
receiving the second part of the satellite data for the priority area;
for the priority area, performing the second process on the second part of the satellite data to identify individual tree and obtain tree parameters of each identify tree;
using the anisotropic equation to estimate a forest carbon storage for the priority area, based on the tree parameters of each identified tree.
